(19) United States
(12) Patent Application Publication
(10) Pub. No.: US 2013/0307229 A1
(43) Pub. Date: Nov. 21, 2013

(54) COMPRESSIBLE PACKING

(71) Applicant: Teadit N.A., Inc., Pasadena, TX (US)

(72) Inventors: Jose Carlos Veiga, Rio de Janeiro (BR); Carlos Daniel Braga Girao Barroso, Rio de Janeiro (BR)

(21) Appl. No.: 13/895,142

(22) Filed: May 15, 2013

Related U.S. Application Data
(60) Provisional application No. 61/647,385, filed on May 15, 2012.

(51) Int. Cl. F16J 15/10

(52) U.S. Cl. CPC F16J 15/104
USPC 277/652

(57) ABSTRACT

A compressible anti-extrusion packing for sealing valve stems, shafts and rods having an interbraided, round braided or square braided outer layer disposed over a densified interbraided, round braided or square-braided core. In certain embodiments, the compressible packing includes a metal jacketed flexible graphite yarn interbraided as a core and an interbraided outer layer made of flexible graphite yarn with a carbon carrier. In one embodiment, the metal jacket is a knitted metal jacket. The core is densified by mechanical compression to control density and size.

### CROSS-REFERENCE TO RELATED APPLICATION

The present application claims the benefit of the filing date of U.S. provisional patent application No. 61/647,385 filed May 15, 2012. The entire disclosure of the provisional application is hereby incorporated herein by this reference.

### FIELD OF THE INVENTION

The present invention relates to a compressible packing for sealing valve stems, shafts and rods. More particularly, the present invention relates to a compressible packing having at least one interbraided layer disposed over a densified interbraided core.

### BACKGROUND

Mechanical equipment used in the handling of liquids or gases may be subject to leakage problems, for example, valve stems, shafts or rods. The successful use of such equipment to contain and handle liquids or gases requires adequate control of this leakage, and several sealing methods and devices have been used to achieve such leakage control.

Compression packing is one of the most common devices used in sealing, and is used in many industries, including chemical, pharmaceutical, marine, sewage, and others. Compression packing involves the insertion of packing devices made from soft, pliant materials into the space (i.e., the stuffing box) between a rotating or reciprocating member of a pump or valve and the body of the pump or valve. When pressure is transmitted to the packing materials, the materials expand against the stuffing box and the valve or pump member, thereby creating a seal.

Compression packing helps control leakage of any type of fluid under a number of different conditions, such as temperature and pressure. Compression packing devices can be used in a number of different kinds of mechanical equipment, such as pumps, mixers, blowers, valves, and others.

The performance of certain types of compression packing may be improved with lubricants. Such lubricants may come from an external source, a built-in liquid or solid lubricant, or the intrinsic lubricating properties of the packing material.

Because compression packings are used in many different types of equipment under a broad range of conditions, they come in a wide variety of constructions, configurations, materials, dimensions, shapes and sizes.

The following is a description of the most common packing constructions and their characteristics.

A square braid packing is formed by weaving strands of yarns, rovings, ribbons, and other various materials, either alone or in combination, over and under other strands running in the same direction. Such processing can yield packings either in a square or a rectangular cross-section. The square braid packings, which are usually soft and pliable and capable of carrying a large percentage of lubricant, are typically used for high-speed rotary service at relatively low pressure. Additionally, the softness of a square braid packing allows for its use on older or worn equipment. Square braid packings commonly come in nominal sizes of up to 6.4 mm (¼ inch). A 2-track square braid, in which eight yarns are woven around 4 corner strands into a 2-track plait, may form rougher packings in larger dimensions. The braiding yarns weave through the packing, thereby improving the ability of the packing to resist unraveling even when a strand is damaged. While the corner strands provide stability to the packing, the square braid remains flexible and easy to make.

An interbraid packing, also called a cross-braid, lattice braid, or diagonal braid packing, is made by weaving yarns, rovings, ribbons, and other forms of various materials, either alone or in combination, in a crisscross manner from the surface diagonally through the body of the packing. Each strand is strongly locked by other strands, thereby providing an overall solid integral structure that generally resists unraveling and contains no jackets or plaits that may wear or loosen. The weaving pattern of such interbraiding evenly distributes the strands throughout the packing and yields a dense, flexible structure that may exhibit improved lubricant retention.

Interbraid packings may be used in many different types of equipment, including in valves, agitators, pumps (reciprocating and centrifugal), expansion joints, and for oven door or static sealing. Where a larger cross-section is needed, a 3- or 4-track diagonal braid may be used, so named because the additional strands yield diagonal tracks. The construction of a 3-track braid, which commonly comes in nominal sizes of between 4.8 and 12.7 mm ( 3/16 and ½ inch), involves the use of braiding machines usually having between 12 to 20 carriers. For 4-track braids, which typically come in dimensions from 9.5 to 76.2 mm (⅜ to 3 inches), a braiding machine having 24, 32, or more carriers is used.

Use of a higher number of yarn carriers may yield finer surface structures in conjunction with larger packing dimensions, thereby allowing for a better contact between packing, shaft, and housing. Thinner yarns generate a denser braid, improving the impregnation retention and minimizing the leakage paths.

Another kind of interbraid packing, known as a corner reinforced packing, involves the use of reinforcing fibers in the corners of the packing and can involve one of two separate constructions. In the first construction, a fiber is inserted in each corner of the packing, running longitudinally, and the jacket is braided around the fibers to form what are known as corner posts. The presence of the corner posts adds tensile strength to the corners of the packing. The second construction, sometimes called a “cross-over track” involves the use of a stronger fiber that is woven only in the packing corners, which fiber adds strength and extrusion resistance to the packing. Also, in this construction, a fiber with more lubricity or heat dissipation is used between the packing corners to reduce friction. Corner reinforced packings are suitable for applications with increased abrasiveness, combined with high speed rotating pumps.

Braid-over-braid packing includes concentric or round braids that include a thin tubular jacket made from yarns, rovings, ribbons, and other forms of materials, which is braided around a core material.

Like diagonal braid packing, the braid-over-braid packing construction also provides a fine and dense surface structure, but is not as abrasion resistant. Several layers of braid-over-braid construction may be braided over a core to increase the packing size or density. Depending on the size of the packing machines, 16, 48, or more carriers may be used. Additionally, core materials can include either parallel or twisted yarns, both of which provide elasticity and flexibility. Cores made from extruded rubber or elastomers may also be used.

Braid-over-braid packing can have a square, rectangular or round cross-section, depending on the shape of the packing. Large endless concentric packing rings can be produced with special braiding machines where the top of the machine can be split.

Braid-over-braid packing, which is relatively dense, is suitable for use in high-pressure, slow-speed applications such as valve stems, expansion joint, and groove gasketing.

Another type of packing construction, known as braid-over-core, involves the braiding of one or more jackets of yarns, ribbons, rovings, or other forms of various materials over a core, which may be twisted, knitted, wrapped or extruded. This type of construction can be used to make packing of a variety of densities and cross-sections.

In addition to each individual packing construction, a combination of two or more packing styles may be used, known as a combination packing set. A common reason for using a combination packing set is to prevent extrusion, such as through the use of anti-extrusion rings installed at both ends of the packing set. These rings are able to resist higher pressures than the packing material between them, thereby preventing extrusion of the packing through the clearances in the stuffing box. The rings can also serve as wipers to maintain loose particles of packing material in the stuffing box. Additionally, soft packing requires end rings to prevent movement through clearances under low pressure conditions. One typical combination packing set involving anti-extrusion rings includes carbon filament end rings with flexible graphite rings. End rings made of metal discs or machined plastics, or other similar materials, may also used. For example, these rings may be used on the media side of the packing set to help keep abrasive materials out of the stuffing box.

Bulk packing, a homogeneous material that comes in powdered, shredded, or fibrous form, is highly conformable and therefore can be used in a variety of stuffing box sizes. Bulk packing materials may be used alone or in combination. One type of bulk packing, called an injectable packing, involves the injection of packing material at high pressures to replenish a seal on equipment during operation. Because the packing can be injected during operation, unnecessary downtime can be avoided.

Twisted packing is made by twisting rovings, yarns, ribbons, and other forms of various materials together around a core to obtain the desired size. When yarns or rovings are involved, strands from larger sizes can be untwisted and removed. The remaining packing will then fit a smaller annular size stuffing box. In this way, a single packing size can be used for several stuffing box sizes. Metallic materials used in the packing can resist high temperatures and pressures, as well as fluid penetration, and they can be made to conform to the irregularities of worn equipment.

Die-formed packing comes in a pre-compressed ring form. This type of construction involves the hydraulic compression of packing materials within a tooling die of a specified size. In this manner, packing materials can be supplied with a specific density and size.

Besides these above packings, there are others types of packing construction, such as extruded packing, laminated packing, wrapped, rolled and folded packing, molded packing, machined packing rings and flexible graphite tape.

The very low emissions rates mandated by regulatory agencies require that a very high seating stress be applied to the packing. This very high stress typically causes standard packing to extrude between the valve stem and the stuffing box.

Conventional packing for control valves in processes where a tight seal is required involving high temperatures include the use of flexible graphite packing, flexible graphite packing reinforced with nickel alloy and carbon corner reinforced flexible graphite packing. None of these conventional packings, however, offers a complete and effective solution. The flexible graphite packing extrudes under high installation stresses, the use of nickel alloy to reinforce the flexible graphite packing scratches the stem surface creating leak paths, and the use of carbon corner reinforced flexible graphite packing reduces the thermal resistance of such packing.

Hydrocarbon processing in refineries and petrochemicals requires packing to be fire resistant. International Standard API 607/ISO 10497: Testing of valves—Fire Type-Testing Requirements specifies fire type-testing requirements and a fire type-test method for confirming the pressure-containing capability of a packing sealed valve under pressure during and after the fire test. In order to be used in refineries and petrochemicals the packing must have this approval guaranteeing the ability of the packing to seal in the event of a fire.

Either or both of flexible graphite and carbon corner reinforced packing are usually used for packing in hydrocarbon processing in refineries and petrochemical applications. The use of these packing materials, however, requires special attention to the possibility of galvanic corrosion, an electro-chemical reaction occurring between a metal and graphite or other carbon material, or between two different metals, that are in contact with an electrically conductive fluid. Under these conditions, corrosion of the material closer to the anodic end of the galvanic scale may occur. The degree of separation between the positions of the two materials on the galvanic scale determines how fast corrosion will occur, with a larger difference yielding a faster corrosion rate.

Galvanic corrosion is most commonly encountered in the compression packing industry when a carbon or graphite packing set is used to pack a valve having a stainless steel stem. Since steel is more anodic than carbon or graphite materials, when the valve is exposed to liquid-state water for a length of time, such as in a hydrostatic test, the stem will be corroded.

Conventional packing uses lubricants and impregnants commonly added to the packing during braiding which leads to a high amount of impregnation. Standard blocking and lubrication agents, however, are not fire resistant reducing the overall ability of such packing to resist under fire conditions as simulated on API 607/ISO 10497: Testing of valves—Fire Type-Testing Requirements. However, the lack of these materials increases considerably the valve operating torques.

### BRIEF DESCRIPTION OF THE DRAWINGS

FIG. 1 illustrates a partially exploded view of an embodiment of the compressible packing according to the present invention.

FIG. 2 illustrates a core made from flexible graphite yarn reinforced with a metallic wire knitted jacket.

FIG. 3 illustrates a flexible graphite yarn with a carbon carrier.

FIG. 4 is a cross-sectional view of an embodiment of the present invention.

FIG. 5 is a schematic view of types of braiding (square braiding, interbraiding and round braiding).

FIG. 6 illustrates an embodiment of the compressible packing according to the present invention for larger size cross-section packing compared to the smaller size cross-section packing shown in FIG. 1.

FIG. 7 is a schematic view of a galvanic cell used to evaluate corrosion inhibitor efficiency.

FIG. 8 illustrates comparative results of the efficiency of zinc wires and zinc powder as a corrosion inhibitor.

FIG. 9 illustrates comparative torque measurements between packing with and without lubricating coatings.

FIG. 10 illustrates comparative API 622 fugitive emission test results of the packing according to embodiments of the present invention compared to a prior art product.

### DETAILED DESCRIPTION

Reference is now made to the drawings that illustrate certain embodiments of the present invention. It should be understood that the invention is not limited to the embodiments shown in the drawings.

The apparatus of the present invention provides a compressible anti-extrusion packing for sealing valve stems, shafts and rods. According to an embodiment of the present invention, the compressible packing has an interbraided, round braided or square braided outer layer disposed over a densified interbraided, round braided or square-braided core. According to certain embodiments of the present invention, the square-braided core and outer layer are used for small cross-section packing, i.e. those having a cross-section of up to 6.4 mm (¼ inch) and the interbraided and round braided core and outer layer are used for larger packing with cross-sections greater than 6.4 mm (¼ inch). According to one embodiment, the compressible packing includes a metal jacketed flexible graphite yarn interbraided as a core and an interbraided outer layer made of flexible graphite yarn with a carbon carrier. In one embodiment, the metal jacket is a knitted metal jacket. The interbraided, round braided or square braided core is densified by mechanical compression to control density and size. Unlike the die-formed rings, the braid-over-core or the braid-over-braid type of packing constructions, the embodiments of the compressible anti-extrusion packing of the present invention include packing that has an interbraided, round braided or square braided layer disposed over a mechanically densified density controlled interbraided, round braided or square braided core. The interbraided, round braided or square braided outer layer of the packing is made with a flexible graphite carbon reinforced yarn which is free of any type of metals that may scratch the stem, shaft or rod surface. The densified anti-extrusion core prevents the packing from extruding and the soft pliable interbraided, round braided or square braided outer layer optionally integrated with one or more blocking and lubrication agents prevents stem, shaft or rod damage and provides long service life. According to one embodiment, the interbraided, round braided or square braided core has a density of between about 1.4 g/cm³ and 2.2 g/cm³. In another embodiment, the final packing has a density of between about 1.0 g/cm³ and 2.0 g/cm³. According to another embodiment, the compressible packing was tested and passed the International Standard API 607/ISO 10497: Testing of valves—Fire Type-Testing and is therefore fire safe.

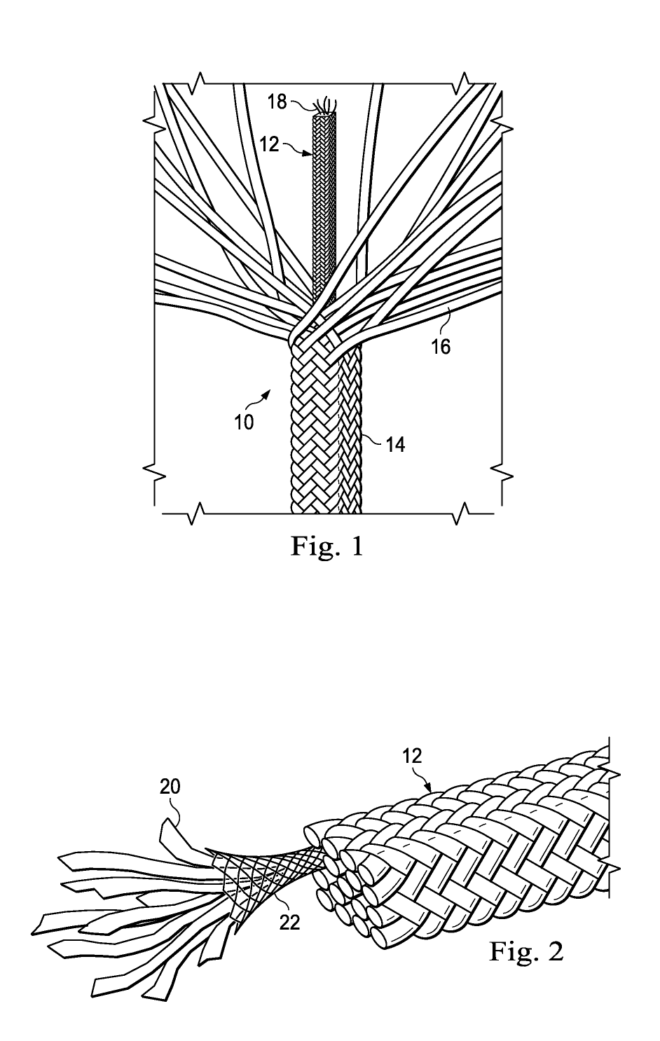

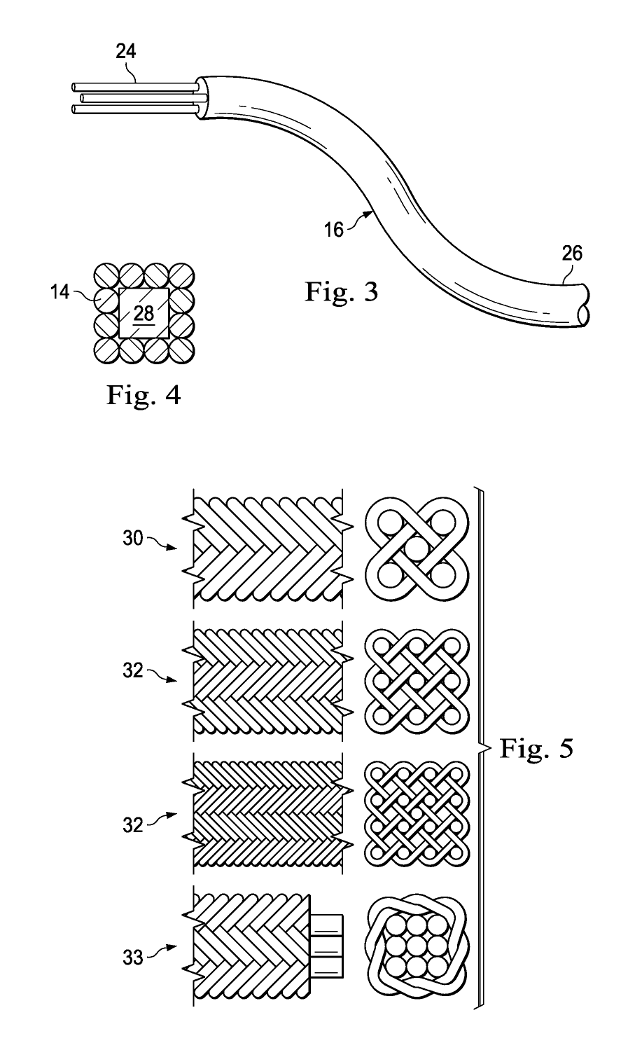

FIG. 1 illustrates a partially exploded view of an embodiment of the compressible packing according to the present invention. As shown in FIG. 1, the illustrated embodiment is an anti-extrusion compressible packing 10 which includes a core 12 made of an interbraided, round braided or square braided metal-jacketed flexible graphite yarn, as described further herein, and an outer layer 14 made of an interbraided, round braided or square braided flexible graphite carbon reinforced yarn 16. As shown in FIG. 2, the interbraided, round braided or square braided core 12 is made from flexible graphite yarn 20 jacketed with high tensile strength metal wires 22 such as nickel alloy wires, stainless steel wires or any other suitable metal wires which are well known to those of ordinary skill in the art. The flexible graphite yarn 20 jacketed with high tensile strength metal wires 22 can be obtained from numerous entities, including Nippon Pillar Packing Co. Ltd, HP Materials Solutions, Inc. and Zhejiang Cathay Packing & Sealing Co. Ltd. As shown in FIG. 3, the flexible graphite carbon reinforced yarn 16 of the outer layer 14 includes filaments of carbon fiber 24 surrounded by graphite flakes that typically have been exfoliated, calendared and folded over to compose the yarn 26. The flexible graphite carbon reinforced yarn 16 can be obtained from numerous entities, including EGC Entreprises Inc. and Zhejiang Cathay Packing & Sealing Co. Ltd.

In certain embodiments of the present invention, corrosion inhibitors may be added to inhibit galvanic corrosion. Such corrosion inhibitors may include passive corrosion inhibitors and/or active corrosion inhibitors. According to one embodiment of the present invention, the passive corrosion inhibitors may include, barium molybdate, sodium molybdate and phosphates. According to another embodiment of the present invention, active corrosion inhibitors are added to the core to inhibit galvanice corrosion. Such corrosion inhibitors may include metals that are more anodic than the metals typically used in the manufacturing of pumps and valves. According to certain embodiments of the present invention, the corrosion inhibitors may include tin, aluminum, uranium, cadmium, beryllium, zinc and magnesium. In certain particular embodiments, the corrosion inhibitor is zinc. As shown in FIG. 1, in certain embodiments, the corrosion inhibitor is added to the core in wire form. Those of ordinary skill in the art will recognize, however, that the corrosion inhibitor may be present in any suitable form.

The interbraided, round braided or square braided core 12 is densified through a calendaring process which involves mechanical compression and is well known to those of ordinary skill in the art. The calendaring process allows for control of the size and density of the interbraided, round braided or square braided core 12, depending on the conditions under which the anti-extrusion packing must perform.

As such, unlike other types of compression packing constructions, like the die-formed rings, the braid-over-core and the braid-over-braid type of packing constructions, the compressible anti-extrusion packing according to certain embodiments of the present invention, includes an interbraided, round braided or square braided outer layer 14 disposed over a mechanically densified, density-controlled interbraided or square braided core 12. The interbraided, round braided or square braided outer layer 14 of the packing is made from flexible graphite carbon reinforced yarn 16 which is free from any type of metal wires.

According to certain embodiments, the interbraiding, round braiding or square braiding for the core 12 and the interbraided, round braided or square braided outer layer 14 is achieved by diagonally weaving the flexible graphite yarns 20 and 16, respectively, in a crisscross manner from the surface of the core 12 or outer layer 14 through its body. Because of such interbraiding, round braiding or square braiding, the various strands of the flexible graphite yarns 20 and 16 are locked to each other, respectively, providing an overall solid integral structure that generally resists unraveling. The weaving pattern of such interbraiding, round braiding or square braiding evenly distributes the flexible graphite yarns 20 and 16 throughout the core 12 and the outer layer 14, respectively, and yields an overall dense and flexible structure. The interbraiding, round braiding or square braiding shown in the illustrated embodiments of FIGS. 1 and 2 includes flexible graphite yarns 16 and 20, but those of ordinary skill in the art of compression packing will understand that other materials, and forms of these materials other than yarns, including tapes, rovings, ribbons and others, may be used to make the interbraided, round braided or square braided core 12 and the interbraided, round braided or square braided outer layer 14.

As noted above, the core 12 is densified through a calendaring process which allows for control of the size and density of the interbraided, round braided or square braided core 12. As shown in FIG. 4, this densified core 12 prevents packing extrusion when it is subjected to the high stress used on valve packing installation. It acts as a “die-formed”, anti-extrusion internal ring 28 that is disposed within the outer layer 14.

According to one embodiment for making the density controlled core 12 so that it will have a desired density that will guarantee the anti-extrusion properties of the final packing, for relatively small-size cross-section packings, as shown in FIGS. 1 and 5, the core includes a single interbraided 32, round braided 33 or square braided 30 core 12.

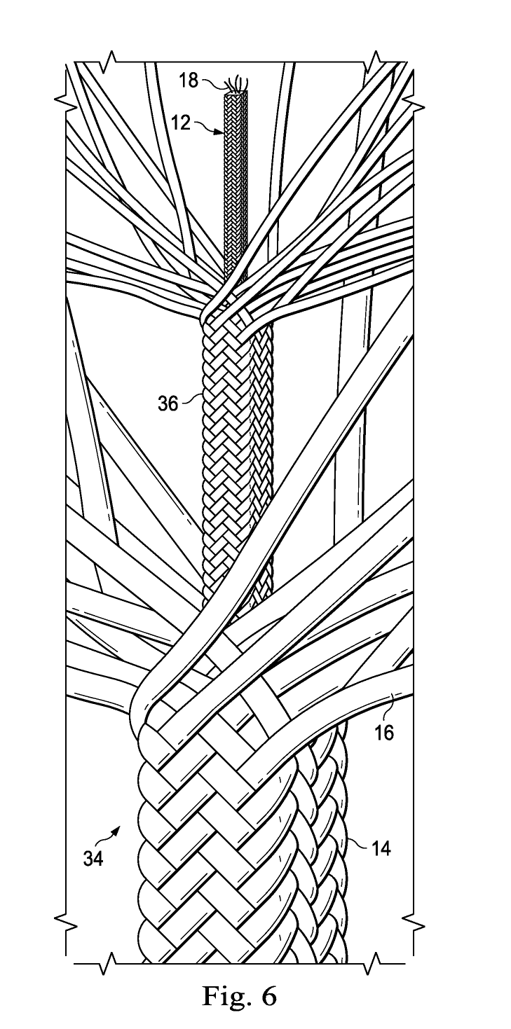

As shown in FIG. 6, according to another embodiment for making the density controlled core so that it will have a desired density that will guarantee the anti-extrusion properties of the final packing, for relatively large-size cross-section packings, the packing 34 includes the core 12, an interbraided 32, round braided 33 or square braided 30 layer 36 disposed over the interbraided 32, round braided 33 or square braided 30 core 12 and the outer layer 14 made of an interbraided flexible graphite carbon reinforced yarn 16.

In certain embodiments of the present invention, and as discussed above, corrosion inhibitors may be added to inhibit galvanic corrosion. Similar to FIG. 1 and as shown in FIG. 6, wires 18 may be added to the core 12 to inhibit galvanic corrosion. Those of ordinary skill in the art will recognize, however, that the corrosion inhibitor may be present in any suitable form.

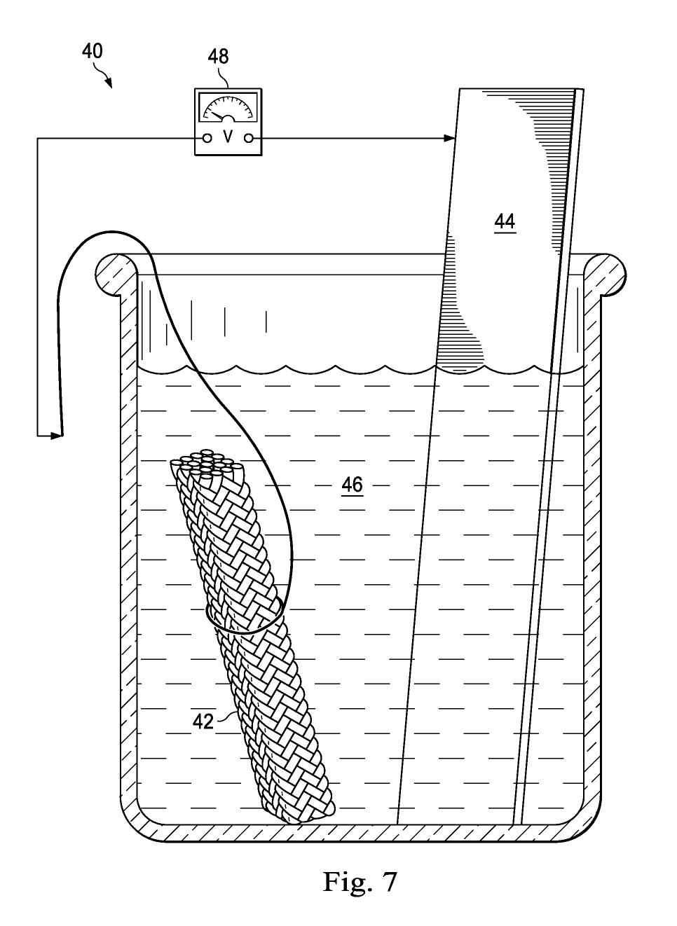

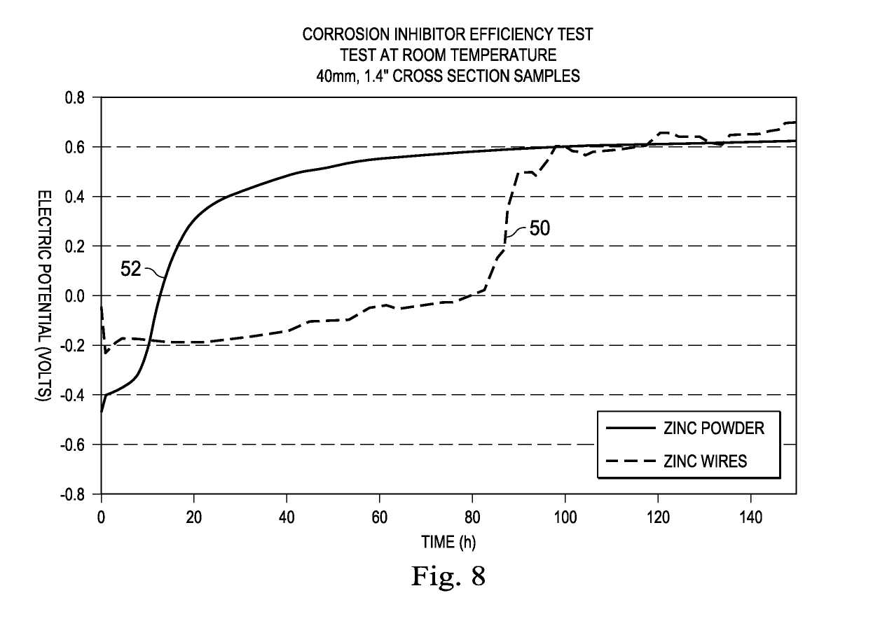

Laboratory tests were developed to measure and compare the efficiency of various galvanic corrosion inhibitors. As shown schematically in FIG. 7, the tests were conducted with a galvanic cell 40 where the compressible packing 42 and a stainless steel bar 44 act as electrodes. They were both immersed in an electrolyte solution 46 and were connected to each other thought a voltmeter 48 that recorded the electric potential difference between the packing 42 and the stainless steel bar 44. While the corrosion inhibitor within the packing 42 was functioning, which simulated how the corrosion inhibitor would protect a stem, shaft or rod, electrons were moving from the packing 42 towards the steel bar 44. This direction was indicated by the voltage sign. Eventually, the corrosion inhibitor was consumed, which simulated the point at which corrosion of the stem, shaft or rod would begin, and this was signaled by a change in the direction of the electron flow. As shown in FIG. 8, this test indicated that zinc wires offer longer protection 50 than zinc powder 52 and that zinc wires will serve as a suitable corrosion inhibitor in embodiments of the compressible packing according to the present invention.

According to certain embodiments of the present invention, in addition to the materials used for interbraiding, an external coating of lubrication and blocking agent is added.

According to certain embodiments of the present invention, a very thin coat of external lubricant is used to reduce stem torque without detracting from the fire resistance of the packing. The coat is only applied externally, according to certain embodiments, and represents less than 20%, less than 10%, or less than 5% of the total mass of the packing. Such blocking and lubricating agents may include any number of agents well known to those of ordinary skill in the art, such as animal fats, vegetable oils, polytetrafluoroethylene (“PTFE”) (including a PTFE dispersion), petroleum or mineral lubricants, synthetic lubricants, silicones, chlorofluoro-carbons, graphite (including graphite flakes), mica, tungsten disulfide, molybdenum disulfide, or greases.

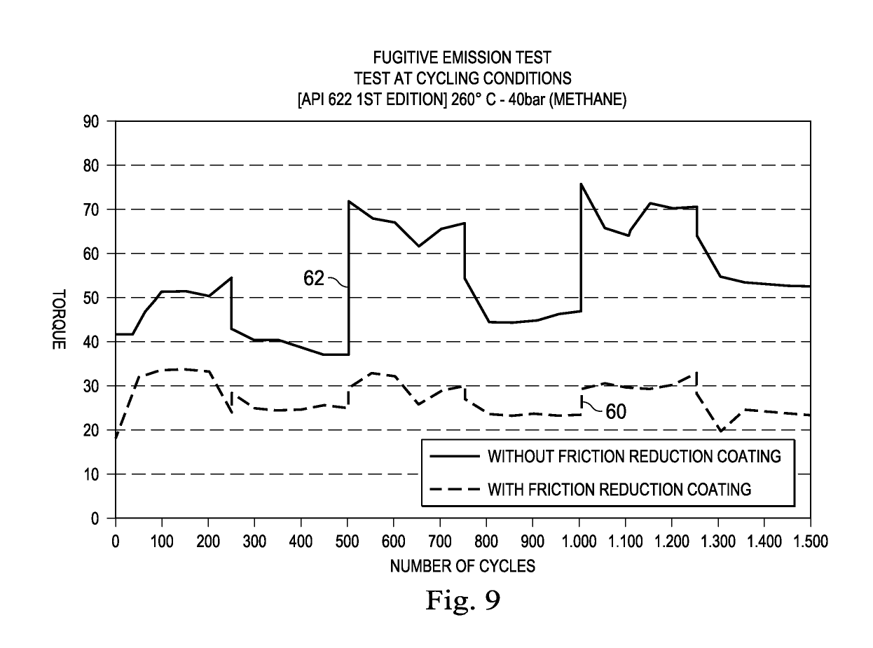

As shown in FIG. 9, an external coating of a PTFE lubrication and blocking agent reduces friction 60 compared to a packing that does not include an external coating of lubrication and blocking agent 62, and keeps the stem torque under operational level. The lower values of torque to rotate the valve stem indicates a lower friction of the PTFE coated packing 60 compared to the non-coated packing 62. PTFE can be obtained from numerous entities, including Dupont and Daikin Industries, Ltd.

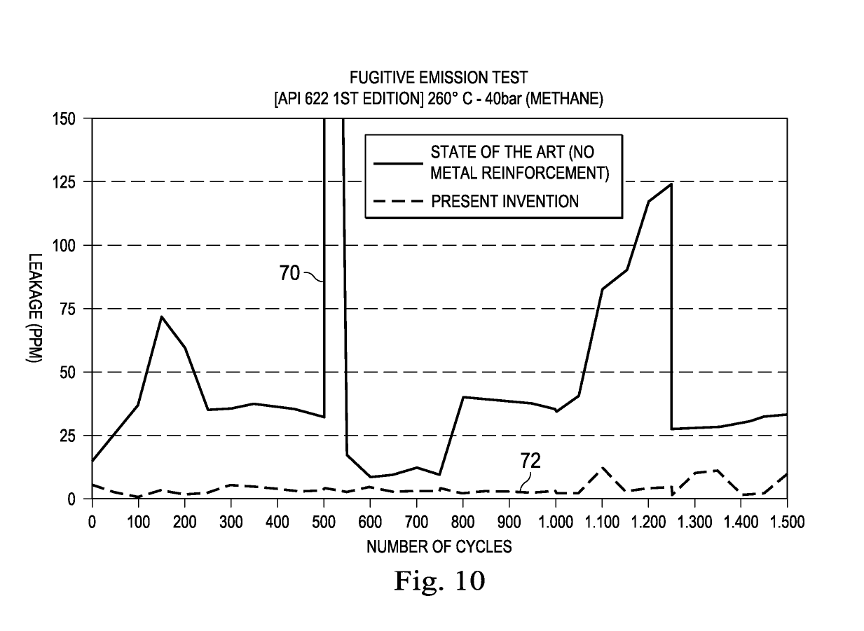

Laboratory fugitive emission tests conducted according to API 622 First Edition Standard-Type Testing of Process Valve Packing for Fugitive Emissions present a reliable basis for comparison among packings. As shown in FIG. 10, when compared to a conventional compressible packing with no metal reinforcement 70, the embodiments of the compressible packing according to the present invention 72 demonstrate superior performance in terms of a reduction in leakage.

The embodiments of compressible packing of the present invention were developed to resist the high installation stress required to assure a tight seal under the temperature cycles and the chemicals involved in the processes and equipment in which the packing may be used. The particular construction assures the low leak rates mandated by regulations are maintained while simultaneously keeping stem torque under operational levels. Specifically, the mechanically densified, density-controlled core prevents extrusion of the packing, while the soft pliable outer interbraided layer, integrated with its blocking and lubricating agents, if any, prevents stem damage and provides long service life.

It is understood that variations may be made in the foregoing without departing from the scope of the disclosure.

In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes and/or procedures may be merged into one or more steps, processes and/or procedures. In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those of ordinary skill in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, any means-plus-function clauses are intended to cover the structures described herein as performing the recited function and not only structural equivalents, but also equivalent structures.

1. A compressible packing for sealing valve stems, shafts and rods, comprising an outer layer comprising a first material and a mechanically densified core comprising a second material.

2. The compressible packing according to claim 1, wherein the first material comprises a flexible graphite yarn.

3. The compressible packing according to claim 2 wherein the flexible graphite yarn comprises a carbon carrier.

4. The compressible packing according to claim 1, wherein the outer layer comprises interbraided strands of the first material.

5. The compressible packing according to claim 1, wherein the outer layer comprises round braided strands of the first material.

6. The compressible packing according to claim 1, wherein the outer layer comprises square braided strands of the first material.

7. The compressible packing according to claim 1, wherein the core comprises interbraided strands of the second material.

8. The compressible packing according to claim 1, wherein the core comprises round braided strands of the second material.

9. The compressible packing according to claim 1, wherein the core comprises square braided strands of the second material.

10. The compressible packing according to claim 1, further comprising an active corrosion inhibitor.

11. The compressible packing according to claim 10, wherein the corrosion inhibitor comprises zinc.

12. The compressible packing according to claim 10, wherein the corrosion inhibitor comprises zinc wire.

13. The compressible packing according to claim 1, further comprising a passive corrosion inhibitor.

14. The compressible packing according to claim 13, wherein the corrosion inhibitor is selected from the group consisting of phosphate, barium molybdate and sodium molybdate.

15. The compressible packing according to claim 1, further comprising a lubricant.

16. The compressible packing according to claim 15, wherein the lubricant is selected from the group consisting of animal fats, vegetable oils, polytetrafluoroethylene, polytetrafluoroethylene dispersions, petroleum lubricants, mineral lubricants, synthetic lubricants, silicones, chlorofluoro-carbons, graphite, graphite flakes, mica, tungsten disulfide, molybdenum disulfide, and greases.

17. The compressible packing according to claim 15, wherein the lubricant is selected from the group consisting of graphite flakes, polytetrafluoroethylene and combinations thereof.

18. The compressible packing according to claim 15, wherein the lubricant comprises up to 20% by weight of the packing.

19. The compressible packing according to claim 1, wherein the packing has a density of from about 1.0 g/cm³ to about 2.0 g/cm³.

20. The compressible packing according to claim 1 wherein the second material comprises a flexible graphite yarn.

21. The compressible packing according to claim 20 wherein the flexible graphite yarn comprises a metal jacket.

22. The compressible packing according to claim 21 wherein the metal jacket comprises a high tensile strength material selected from the group consisting of nickel alloy and stainless steel wire.

23. The compressible packing according to claim 1 wherein the core has a density of from about 1.4 g/cm³ to about 2.2 g/cm³.

24. A compressible packing for sealing valve stems, shafts and rods, comprising a densified core of interbraided metal-jacketed flexible graphite yarn and an outer layer of interbraided flexible graphite carbon reinforced yarn.
